(19) United States
(12) Patent Application Publication
(10) Pub. No.: US 2026/0284564 A1
(43) Pub. Date: Sep. 24, 2026

(54) AIR FILTRATION ASSEMBLY WITH AIR QUALITY CONTROL

(71) Applicant: Apex Brands, Inc., Apex, NC (US)

(72) Inventor: Scott BUBLITZ, Denver, NC (US)

(21) Appl. No.: 19/489,324

(22) PCT Filed: Apr. 30, 2024
(86) PCT No.: PCT/US2024/026963

§ 371 Date: Dec. 2, 2025

Related U.S. Application Data
(60) Provisional application No. 63/472,852, filed on Jun. 14, 2023.

(51) Int. Cl. B01D 46/44; B01D 46/46; B23K 3/08

(52) U.S. Cl. CPC B01D 46/442; B01D 46/46; B23K 3/08; B01D 2279/35

(57) ABSTRACT

An air filtration assembly for filtering gas or particles generated responsive to operation of a work tool may include an intake which may be repositionable relative to a work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The exhaust may include an air quality control sensor that may measure a composition of the air exiting the exhaust. The processing circuitry may shut down the work tool based on the measurement of the composition of the air from the air quality control sensor.

### TECHNICAL FIELD

Example embodiments generally relate to air filtration assemblies and, in particular, relate to such assemblies having performance assurance measures.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located proximate to other workstations and sometimes within the same room. Thus, an air filtration assembly may be employed to filter the air proximate to the workstation where the task may be taking place. Common considerations to make regarding the configuration and use of the air filtration assembly may include ensuring it is adequately sized for the space it is occupying, ensuring it is operating effectively, and improving its overall ease of operation/user experience. Thus, it may be desirable to provide an improved air filtration assembly to address some of the above considerations to create an environment that may be safer for the operator and other potential surrounding workstations.

### BRIEF SUMMARY OF SOME EXAMPLES

In an example embodiment, an air filtration assembly for filtering gas or particles generated responsive to operation of a work tool may be provided. The air filtration assembly may include an intake which may be repositionable relative to a work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The exhaust may include an air quality control sensor that may measure a composition of the air exiting the exhaust. The processing circuitry may shut down the work tool based on the measurement of the composition of the air from the air quality control sensor.

In another example embodiment, a work system may be provided. The work system may include a work tool, a workstation at which the work tool may perform a work task, and an air filtration assembly. The air filtration assembly may include an intake which may be repositionable relative to a work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The exhaust may include an air quality control sensor that may measure a composition of the air exiting the exhaust. The processing circuitry may shut down the work tool based on the measurement of the composition of the air from the air quality control sensor.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of an air filtration assembly according to an example embodiment;

FIG. 2 illustrates a perspective view of the air filtration assembly of FIG. 1 in accordance with an example embodiment; and

FIG. 3 illustrates an isolated perspective view of an exhaust of the air filtration assembly of FIG. 1 according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that includes features that improve its operation. In some cases, an air quality control sensor may be employed to ensure the air filtration assembly is properly filtering the air. If the air filtration assembly is found to not be properly filtering the air, the air filtration assembly may shut down a source of airborne pollutants. However, other strategies and features are also contemplated as described in greater detail below.

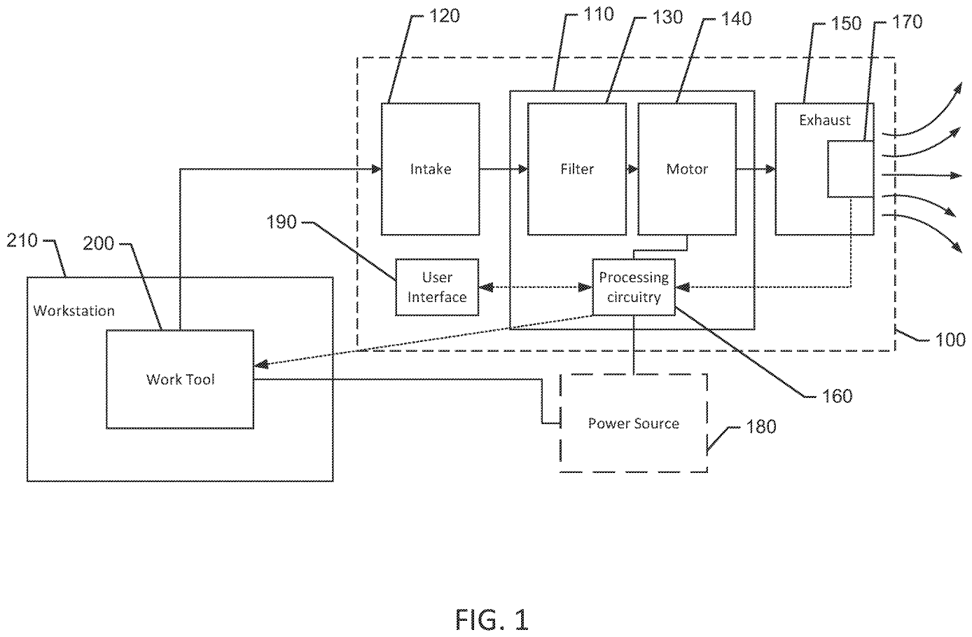

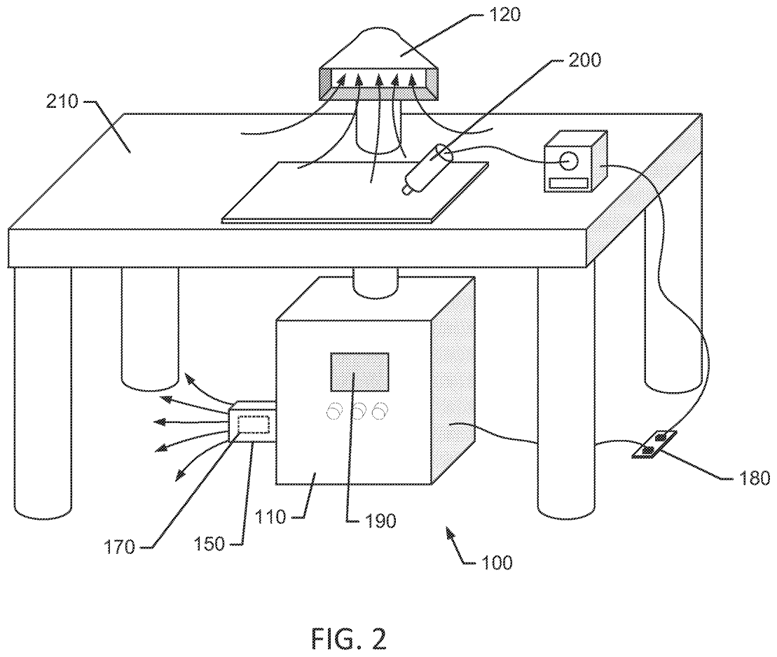

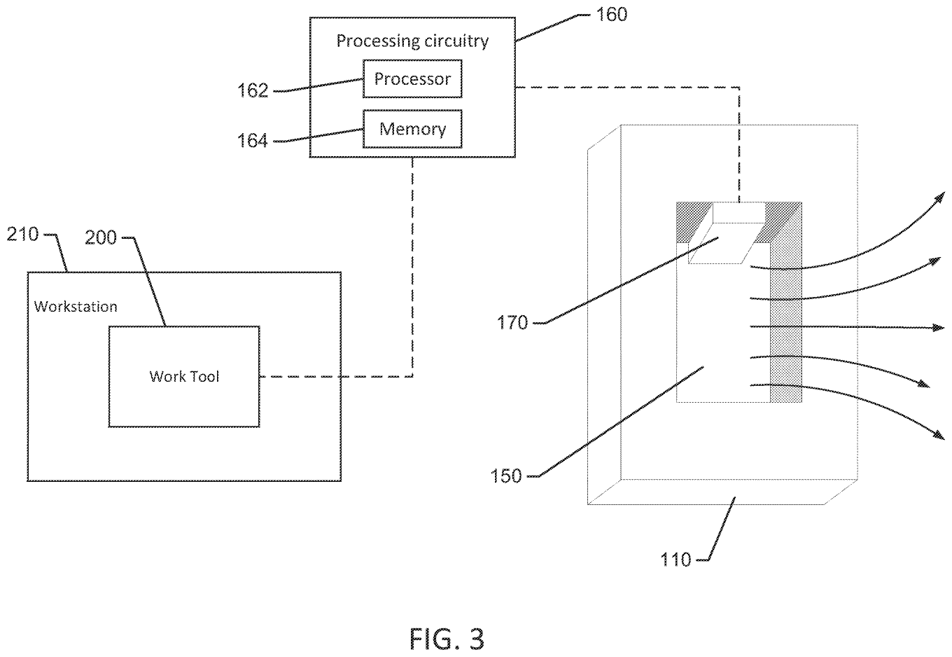

FIG. 1 illustrates a block diagram of an air filtration assembly 100 according to an example embodiment. FIG. 2 illustrates a perspective view of the air filtration assembly 100 set up at a workstation 210 in accordance with an example embodiment. FIG. 3 illustrates the air quality control sensor 170 disposed in the exhaust 150 of the air filtration assembly 100 according to an example embodiment.

The air filtration assembly 100 may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench. In other cases the air filtration assembly 100 may be slightly larger and thus the housing 110 may be configured to be disposed under a desk/workbench. In still another case, the air filtration assembly 100 may be even larger still and configured to be disposed nearby as a standalone assembly. Thus, the housing 110 may take on different shapes and/or sizes depending on the particular needs and configuration of each embodiment dictated by the environment and the particular use case of the air filtration assembly 100.

The housing 110 may also include the intake 120 and the exhaust 150 operably coupled thereto. In this regard, and as shown in FIG. 1, air may enter the air filtration assembly 100 through the intake 120 before proceeding to pass through the filter 130 responsive to the operation of the motor 140 driving a fan or other mechanism to facilitate airflow through the air filtration assembly 100. The air may exit the air filtration assembly 100 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

In an example embodiment, the exhaust 150 may include an air quality control sensor 170 which may measure a composition of the air exiting the exhaust 150. In this regard, the air quality control sensor 170 may monitor the composition of the air exiting the air filtration assembly 100 to detect the presence of certain particulates and/or gasses being released from the exhaust 150. In other words, air exiting the air filtration assembly 100 through the exhaust 150 should, in theory, be clean after having been passed through the filter 130. Thus, the presence of airborne particles and pollutants should be kept to a minimum when the air filtration assembly 100 is operating properly. In an example embodiment, the presence of airborne particles and pollutants could be an indication of a lack of proper function of the air filtration assembly 100, which may be caused by filter depletion, mechanical failure, or any number of reasons.

In some cases, the air quality control sensor 170 may be a volatile organic compound (VOC) sensor that may measure a density of VOC's in the air exiting the air filtration assembly 100 through the exhaust 150. During normal and proper operation of the air filtration assembly 100, the density of VOC's in the exiting air should be below a predetermined density threshold. In an example embodiment, the air quality control sensor 170 may communicate the measured density with the processing circuitry 160 which may compare the measurement of the composition of the air to the predetermined density threshold. In some cases, the predetermined density threshold may be defined by a user of the air filtration assembly 100, but in most example embodiments, the predetermined density threshold may be set and programmed by the manufacturer of the air filtration assembly 100.

The air filtration assembly 100 may be powered by a power source 180 which, according to an example embodiment, may be a source of electrical energy such as a battery or a connection to mains power. Operation of the air filtration assembly 100 may be controlled by the processing circuitry 160 which may be operably coupled to the power source 180 to control the delivery of power to the motor 140 accordingly. In this regard, the processing circuitry 160 may also be operably coupled to a user interface 190 that, in some cases, may be disposed at the housing 110. The user interface 190 may be operable by a user to change certain operating parameters of the air filtration assembly 100, such as powering on/off the air filtration assembly 100 and changing an operating speed of the motor 140, among others. In some cases, the processing circuitry 160 may control the operation of the air filtration assembly 100 automatically responsive to input from the air quality control sensor 170 and without user input from the user interface 190. In another example embodiment, the processing circuitry 160 may operate the air filtration assembly 100 at a set operating speed for specific time intervals responsive to user input at the user interface 190 selecting such a mode of operation.

The processing circuitry 160 may be configured to provide electronic control inputs to one or more functional units of the air filtration assembly 100 and to process data received at or generated by the one or more functional units of the air filtration assembly 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the air filtration assembly 100 to control operation of the assembly.

In some other cases, the user interface 190 may not be disposed at the housing 110 and may instead be disposed at a personal electronic device of the user. In this regard, the user may be able to configure the operation of the air filtration assembly 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user input at the user interface 190 and/or to provide an audible, visual, tactile or other output to the user. As such, the user interface 190 may include, for example, a display, one or more switches, lights, buttons or keys, speaker, and/or other input/output mechanisms. However, more complex interface mechanisms could be provided in some cases. In some cases, the processing circuitry 160 may control the operating speed of the motor 140 based on input provided to the user interface 190 of the air filtration assembly 100.

FIGS. 1 and 2 also depict a work tool 200 and a workstation 210, which the air filtration assembly 100 may be operably coupled to and/or disposed proximate to. In this regard, the workstation 210 may be a table, desk, workbench or any other sort of structure at which a user may perform a work task. In some cases, the workstation 210 may not include a structure at all, and may simply be a general area in which the work tool 200 may be disposed. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration assembly 100, the work tool 200 shown in FIG. 2 may be a soldering tool.

In the embodiment depicted in FIGS. 1-3, the processing circuitry 160 of the air filtration assembly 100 may also be operably coupled to the work tool 200. In this regard, the processing circuitry 160 may be configured to control the operation of both the air filtration assembly 100 and the work tool 200. In other words, the processing circuitry 160 may be configured to shut down the work tool 200 based on the measurement of the composition of the air from the air quality control sensor 170. In some embodiments, such as the one depicted in FIG. 2, the work tool 200 may be wirelessly operably coupled to the processing circuitry 160 via Bluetooth or other means of wireless communication. However, in some other embodiments, the work tool 200 may be operably coupled to the processing circuitry 160 by wire using a data transfer cable (e.g. an Ethernet cable). Thus, responsive to the air quality control sensor 170 measuring a density of VOC's in the air that is greater than or equal to the predetermined density threshold, the processing circuitry 160 may accordingly shut off the work tool 200 so as to terminate the source of the VOC's in the air. The indication from the air quality control sensor 170 that the density of VOC's in the air is greater than or equal to the predetermined density threshold may be an indication that the air filtration assembly 100 may not be functioning properly. Thus, to avoid worsening any air quality metrics in the immediate surroundings of the air filtration assembly 100, the processing circuitry 160 may shut off the work tool 200 so that no more airborne particulates can be released until the air filtration assembly 100 may be deemed to be functioning properly.

In an example embodiment, such as the one depicted in FIG. 2, the processing circuitry 160 may shut down the work tool 200 by transmitting a shutoff signal to the work tool. Additionally, responsive to the air quality control sensor 170 indicating a density of VOC's in the air is equal to or exceeds the predetermined density threshold, the processing circuitry 160 may notify the user, either by the user interface 190 or otherwise, to change the filter 130. In this regard, responsive to receiving the shutoff signal, the work tool 200 may cease to operate until the air filtration assembly 100 has been reset by the user, and ideally serviced to address the root cause of the elevated VOC levels. In some cases, the shutoff signal may be transmitted to the work tool 200 wirelessly, whereas in other cases, the shutoff signal may be transmitted to the work tool 200 by wire. In an example embodiment, the processing circuitry 160 may shut down the work tool 200 by interrupting the power from the power source 180 to the work tool 200, rather than by sending the shutoff signal. In such cases, the work tool 200 may operably couple to the air filtration assembly 100 to receive power from the power source 180 via the air filtration assembly 100 to operate the work tool 200. As such, the processing circuitry 160 may have direct control over the power delivery to the work tool 200 from the power source 180, and may cut off the supply of power to the work tool 200 responsive to the air quality control sensor 170 indicating a density of VOC's in the air is equal to or exceeds the predetermined density threshold.

In some cases, the air filtration assembly 100 may be one assembly amongst others in a larger air filtration system 220. In such cases, the air filtration system 220 may include a plurality of air filtration assemblies 100 perhaps disposed at a plurality of workstations 210. In such cases, the air filtration system 220 may include a main assembly 230 and a plurality of subassemblies 240. The main assembly 230 and the subassemblies 240 may each be an air filtration assembly 100, but the main assembly 230 may be the only air filtration assembly 100 in the air filtration system 220 to include the processing circuitry 160. In this regard, each of the subassemblies 240 may be configured to communicate with the processing circuitry 160 at the main assembly 230 either wirelessly or by wire. Similar to the functionality described above, if the air quality control sensor 170 disposed at the exhaust 150 of any of the main assembly 230 or the subassemblies 240 were to detect a density of VOC's in the air that met or exceeded the predetermined density threshold, then the processing circuitry 160 at the main assembly 230 may shut down the work tool 200 disposed at the workstation 210 where the particular subassembly 240 detected the excessive VOC levels. In some cases, the processing circuitry 160 at the main assembly 230 may shut down all of the respective work tools 200 that may be connected to the air filtration system 220 responsive to detecting the excessive VOC levels.

Some example embodiments may provide for an air filtration assembly for filtering gas or particles generated responsive to operation of a work tool. The air filtration assembly may include an intake which may be repositionable relative to a work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The exhaust may include an air quality control sensor that may measure a composition of the air exiting the exhaust. The processing circuitry may shut down the work tool based on the measurement of the composition of the air from the air quality control sensor.

In some cases, the air filtration assembly described above may be augmented or modified by altering individual features mentioned above or adding optional features. The augmentations or modifications may be performed in any combination and in any order. For example, in some cases, the processing circuitry may shut down the work tool responsive to a density of volatile organic compounds (VOC's) in the air exiting the exhaust being greater than or equal to a predetermined density threshold. In an example embodiment, the processing circuitry may shut down the work tool by transmitting a shutoff signal to the work tool. In some cases, the shutoff signal may be transmitted to the work tool wirelessly. In an example embodiment, the shutoff signal may transmitted to the work tool by wire. In some cases, the processing circuitry may shut down the work tool by interrupting a power supply to the work tool. In an example embodiment, the processing circuitry may notify a user to change the filter responsive to the density of VOC's in the air exiting the exhaust being greater than or equal to the predetermined density threshold. In some cases, the air quality control sensor may be a VOC sensor. In an example embodiment, the work tool may be a soldering tool. In some cases, the work tool may be a laser cutting tool. In an example embodiment, the processing circuitry may control an operating speed of the motor based on input into a user interface of the air filtration assembly.

Some example embodiments may provide for a work system. The work system may include a work tool, a workstation at which the work tool may perform a work task, and an air filtration assembly. The air filtration assembly may include an intake which may be repositionable relative to a work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The exhaust may include an air quality control sensor that may measure a composition of the air exiting the exhaust. The processing circuitry may shut down the work tool based on the measurement of the composition of the air from the air quality control sensor.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration assembly for filtering gas or particles generated responsive to operation of a work tool, the air filtration assembly comprising:
an intake repositionable relative to the work tool;
a housing operably coupled to the intake, the housing comprising a filter, a motor and processing circuitry; and
an exhaust operably coupled to the housing,
wherein the processing circuitry is configured to control the operation of both the air filtration assembly and the work tool,
wherein air enters the air filtration assembly at the intake responsive to operation of the motor, before passing through the filter and exiting out the exhaust,
wherein the exhaust comprises an air quality control sensor that measures a composition of the air exiting the exhaust, and
wherein the processing circuitry is configured to shut down the work tool based on the measurement of the composition of the air from the air quality control sensor.

2. The air filtration assembly of claim 1, wherein the processing circuitry shuts down the work tool responsive to a density of volatile organic compounds (VOC's) in the air exiting the exhaust being greater than or equal to a predetermined density threshold.

3. The air filtration assembly of claim 2, wherein the processing circuitry shuts down the work tool by transmitting a shutoff signal to the work tool.

4. The air filtration assembly of claim 3, wherein the shutoff signal is transmitted to the work tool wirelessly.

5. The air filtration assembly of claim 3, wherein the shutoff signal is transmitted to the work tool by wire.

6. The air filtration assembly of claim 2, wherein the processing circuitry shuts down the work tool by interrupting a power supply to the work tool.

7. The air filtration assembly of claim 2, wherein the processing circuitry notifies a user to change the filter responsive to the density of VOC's in the air exiting the exhaust being greater than or equal to the predetermined density threshold.

8. The air filtration assembly of claim 1, wherein the air quality control sensor is a VOC sensor.

9. The air filtration assembly of claim 1, wherein the work tool is a soldering tool.

10. The air filtration assembly of claim 1, wherein the processing circuitry controls an operating speed of the motor based on input into a user interface of the air filtration assembly.

11. A work system comprising:
a work tool;
a workstation at which the work tool performs a work task; and
an air filtration assembly, the air filtration assembly comprising:
an intake repositionable relative to the work tool;
a housing operably coupled to the intake, the housing comprising a filter, a motor and processing circuitry; and
an exhaust operably coupled to the housing,
wherein the processing circuitry is configured to control the operation of both the air filtration assembly and the work tool,
wherein air enters the air filtration assembly at the intake responsive to operation of the motor, before passing through the filter and exiting out the exhaust,
wherein the exhaust comprises an air quality control sensor that measures a composition of the air exiting the exhaust, and
wherein the processing circuitry is configured to shut down the work tool based on the measurement of the composition of the air from the air quality control sensor.

12. The work system of claim 11, wherein the processing circuitry shuts down the work tool responsive to a density of volatile organic compounds (VOC's) in the air exiting the exhaust being greater than or equal to a predetermined density threshold.

13. The work system of claim 12, wherein the processing circuitry shuts down the work tool by transmitting a shutoff signal to the work tool.

14. The work system of claim 13, wherein the shutoff signal is transmitted to the work tool wirelessly.

15. The work system of claim 13, wherein the shutoff signal is transmitted to the work tool by wire.

16. The work system of claim 12, wherein the processing circuitry shuts down the work tool by interrupting a power supply to the work tool.

17. The work system of claim 12, wherein the processing circuitry notifies a user to change the filter responsive to the density of VOC's in the air exiting the exhaust being greater than or equal to the predetermined density threshold.

18. The work system of claim 11, wherein the air quality control sensor is a VOC sensor.

19. The work system of claim 11, wherein the work tool is a soldering tool.

20. The work system of claim 11, wherein the processing circuitry controls an operating speed of the motor based on input into a user interface of the air filtration assembly.
